(19) United States
(12) Patent Application Publication
(10) Pub. No.: US 2012/0066485 A1
(43) Pub. Date: Mar. 15, 2012

(54) SYSTEM AND METHOD FOR INSTALLING AND CONFIGURING A TAILORED OPERATING SYSTEM AND USER ENVIRONMENT

(76) Inventors: Robert Hosea, Woodstock, GA (US); Robert Leiker, Alpharetta, GA (US); Stephen T. Bowker, Canton, GA (US)

(21) Appl. No.: 13/086,191

(22) Filed: Apr. 13, 2011

Related U.S. Application Data
(60) Provisional application No. 61/323,662, filed on Apr. 13, 2010.

(51) Int. Cl. G06F 15/177; G06F 9/24

(52) U.S. Cl. 713/2; 713/1

(57) ABSTRACT

The systems and methods disclosed can be used for installing and configuring a tailored operating system and user environment including software products and applications on end-user computers. The systems and methods relate generally to software used to boot a computer with a maintenance operating system and to backup selected data to external storage. The software can initiate an installation of a new operating system and then restores the data that was backed up on external storage.

### CROSS REFERENCE TO RELATED PATENT APPLICATION

This application claims priority to U.S. Provisional Application No. 61/323,662 filed Apr. 13, 2010, herein incorporated by reference in its entirety.

### BACKGROUND

Over the years of technology, the number of operating systems and software applications that run on various hardware platforms has grown tremendously. The required labor to install these operating system packages onto personal computers has been a significant cost in the deployment of computers.

These software installations include: desktop operating systems, laptop operating systems, server operating systems, word processors, spreadsheet processors, databases systems, and accounting systems. While it is good that a user has a wide choice of software to choose from, this increase in the number of choices has created a number of problems for administrators who are responsible for installing the software on any number of computer systems.

Software installation of operating systems and applications on a personal computer has, for the most part, required an onsite physical presence of a trained technician that knew the customers' environment, network resources, and installation procedures to install the operating system. As the number of installations of software increases, so does the margin for error. The window of time for installation and upgrades is generally when the user is away from the computer, and this is also the time when limited support is available for installation errors that could occur.

For instance, if a technician is installing new computers and is replacing older computers for a large number of users, he must first install the operating system and then the applications software required for each user to perform his job. If one of these software packages has an issue, whether it be a security issue or missing software prerequisite that didn't get installed first, this will result in additional time required to resolve the issue. This in turn delays the technician and delays the remaining installations for other user's computers, and the result is increased labor cost for installation.

Methods of installing software remotely exist, but they require an operating system and lack the ability to erase the hard drive remotely and completely image the computer in a single data transfer.

The methods that Administrators use today to install software today include these methods:

Technician installs the operating system with physical installation media at the computer and then installs the applications with additional physical media.

Technician Installs the operating system, then uses the application specific installation setup routines to install the applications from a shared network drive.

Technician installs the operating system and then copies the application software over a network, using a file copy program such as File Transfer Protocol (FTP), and then installs the software from a remote location.

Technician uses local tools to capture an operating system and applications and then “push” the image to the computer system where the image is to be installed.

Technician installs the operating system and then uses a third party vendor product to push the application software to the computer system where the application software is to be installed.

As can be seen, these methods require a great deal of manual intervention on the part of the technician and thus are often time-consuming and error prone. The magnitude of these problems greatly increases if a large number of computer systems are to be managed.

With the worldwide utilization of the internet, as well as with global diversification of large enterprises, the remote installation and management of a software system has become even more complex. Enterprises are constantly struggling to offer standardized software environments; yet it is not possible to do so within a distributed enterprise easily.

It is therefore desirable to provide a system that can build workstation software configurations before the physical computer arrives regardless of the hardware specifications of the computer. This allows the new configuration to be built during business hours without end user disruptions, and provides a method for remote testing the software for errors. This system and process allows the image that contains the operating system, applications, and data to be pushed to a new PC in a single data transfer.

### SUMMARY

The systems and methods disclosed can be used for installing and configuring a tailored operating system and user environment including software products and applications on end-user computers. The systems and methods relate generally to software used to boot a computer with a maintenance operating system and to backup selected data to external storage. The software can initiate an installation of a new operating system and then restores the data that was backed up on external storage.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary operating environment;

FIG. 2 is another exemplary operating environment;

FIG. 3A is an exemplary method of operation utilizing a source computer;

FIG. 3B is an exemplary method of operation utilizing a destination computer; and

FIG. 4 is an exemplary method of operation.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Maintenance Operating System (MOS): A MOS can be an operating system that is limited in scope and designed with a small memory footprint, limited features, and is used specifically for the performing the functions of its utility library. In an aspect, this utility is loaded and runs in RAM.

Maintenance Operating Environment (MOE): A Maintenance Operating Environment can be the combination of the MOS and the utility library loaded and running on a RAM Drive of a personal computer. Additionally, the MOE can be focused on a specific function, such as operating system maintenance, upgrades and user migrations.

Upgrade: The term Upgrade can be used to describe the procedure of changing the operating system and application software to a newer release of the software. This can be performed on a physical PC or virtual PC.

Migrate: The term “migrate” can be used to describe the procedure of moving a user's profile and files to another operating environment. This can be on the same PC or either another physical PC or virtual PC.

Replace: The term “replace” can be used to describe the physical PC or virtual PC replacement of a user's operating and application environment.

Refresh: The term “refresh” can be used to describe the replacement of the current operating and application environment on a specific PC. This can be either hardware or operating system or both.

Virtual PC: Virtualization of a PC can be performed by utilizing software that runs on a server that emulates a PC Operating environment. Additionally, virtualization software running on a server can support multiple PC operating environments simultaneously. This in turn can utilize the hardware and software resources of the server rather than a local PC.

Graphical user interface (GUI): A graphical user interface is a type of user interface that allows people to interact with programs in more ways than typing on a PC. A GUI offers graphical icons and visual indicators, as opposed to text-based interfaces.

Boot: The term “boot” can refer to the initial loading of an operating system into a PC's memory for execution. Once the initial load is performed and the operating system is running, a GUI can appear allowing the end-user to utilize features within the operating environment.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Disclosed herein are systems and methods, also referred to herein as the utility, for automating the task of building a personal computer with a designated operating system (OS) and application software that an end-user needs to complete his/her daily tasks. In an aspect, disclosed is a memory resident maintenance operating environment that takes exclusive control of a source computer and one or more destination computers for access to resident resources during the period of migration.

This utility can be deployed at a source computer by a user or by a system administrator from a remote location. Such remote deployment can utilize a network connection between the source computer and an administrator's deployment console. The utility can be deployed on a PC from various media. For standalone use, optical media such CD or DVD may be used. Additionally, solid state memory media such as a USB Flash Drive or an externally attached hard drive can be used. Also, deploying the utility from a network share is an option. The source and destination computers can be the same physical computer or different computers.

In an aspect, the disclosed utility can be loaded onto external storage media. The external storage media can be connected to the source personal computer (PC). The utility media can comprise a dedicated bootable operating system that comprises a utility library of programs that when launched create a Maintenance Operating Environment (MOE). The source PC can be restarted using the MOE.

In an aspect, a Maintenance Operating System (MOS) can initialize and establish the Maintenance Operating Environment. The MOE can run on the source PC utilizing applications from its utility library. In an aspect, the MOE can run on local RAM. Other locally connected storage devices can be mapped as logical disk units, as well as the attached external storage media. The MOE applications can perform a scan for user files and settings on the local storage media. In an aspect, when the scan is finished, the capture of user data can begin automatically. The designated files can be stored on the external storage media. In an aspect, upon completion, the MOS on the source personal computer can be automatically shutdown.

The destination PC can then be started by an attending technician using operating system installation media. This can be from standard optical media such as a CD or DVD, solid state memory such as USB Flash Drive, or from a network share. The operating system image being installed can be from an OS vendor or be a tailored image containing preinstalled applications as required by the end user. The OS installation can then be performed by the technician in accordance with desired configuration requirements. In an aspect, upon completion, the OS can be automatically shutdown.

The external storage media containing the utility, now also comprising user files and settings obtained from the source PC, can be connected to the destination PC. The utility media is started on the destination PC to establish the MOE. The user files and settings are copied to the destination PC's internal storage media from the external storage media. Upon completion, the destination PC can automatically shutdown and the utility media and external storage media can be removed by the attending technician. The destination PC can then be restarted using the new OS tailored for the user.

In an aspect, this utility can be used after one of three determinations is made:

1. A current personal computer/workstation requires an operating system upgrade.

2. A user needs to be migrated to another personal computer/workstation.

3. A personal computer/workstation requires replacing or refreshed.

In an aspect, use of the disclosed systems and methods can be impacted by:

1. Available window of time: Prior to performing these tasks a determination can be made by the user as to the most appropriate window of time to perform maintenance on the designated personal computer. This can be determined by the designated computer's availability during peak and non-peak times. Typically, maintenance described herein can be performed when the designated computer is going to be inactive or during non-peak activity period, but not exclusive to a non-peak period. During this period the designated personal computer will not be available for general use by user.

2. Access to an external storage device: In an aspect, the external storage device can be initially directly connected to the source personal computer to perform the capture and then to the destination personal computer for deployment. Additionally, the external storage media can be a hard disk, flash drive, a biometric encrypted media device, and the like.

3. Installation media containing an operating system for the destination personal computer is required: This media may be in the form of a standard release from the manufacture or a prebuilt operating system media containing additional software and security features typically defined by corporate and large enterprise environments.

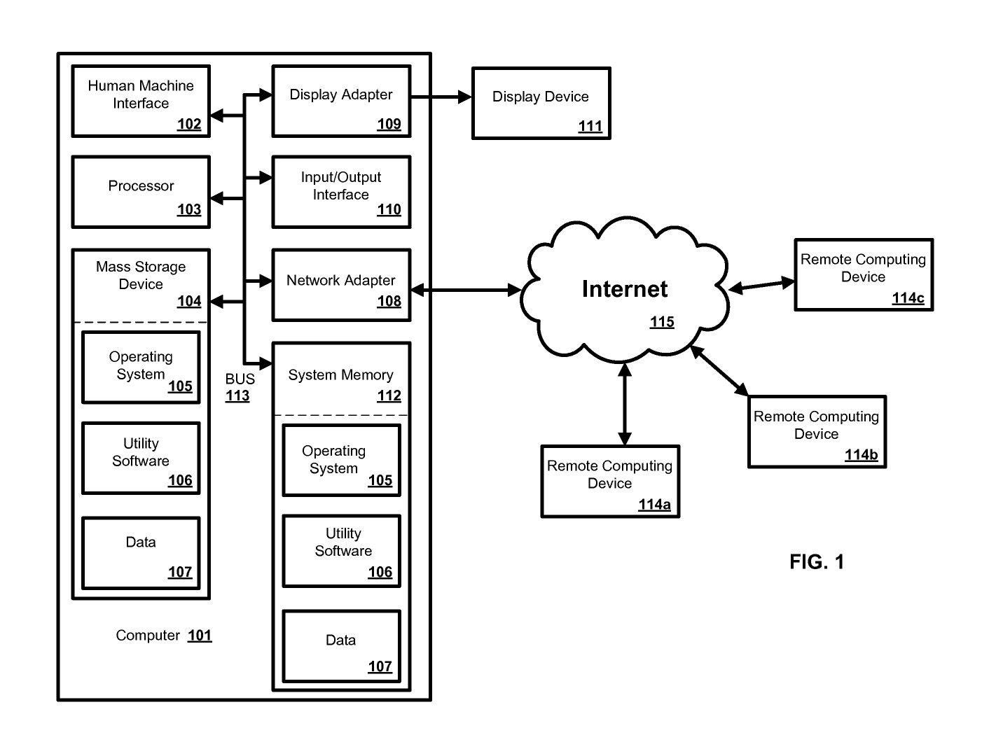

One skilled in the art will appreciate that provided is a functional description and that the respective functions can be performed by software, hardware, or a combination of software and hardware. In one exemplary aspect, the systems and methods can comprise a computer 101 as illustrated in FIG. 1 and described below.

FIG. 1 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, utility software 106, data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as data 107 and/or program modules such as operating system 105 and utility software 106 that are immediately accessible to and/or are presently operated on by the processing unit 103.

In another aspect, the computer 101 can also comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and utility software 106. Each of the operating system 105 and utility software 106 (or some combination thereof) can comprise elements of the programming and the utility software 106. Data 107 can also be stored on the mass storage device 104. Data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems. Data 107 can comprise user settings, user files, one or more operating systems, and the like.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110. Any step and/or result of the methods can be output in any form to an output device. Such output can be any form of visual representation, including, but not limited to, textual, graphical, animation, audio, tactile, and the like.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of utility software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

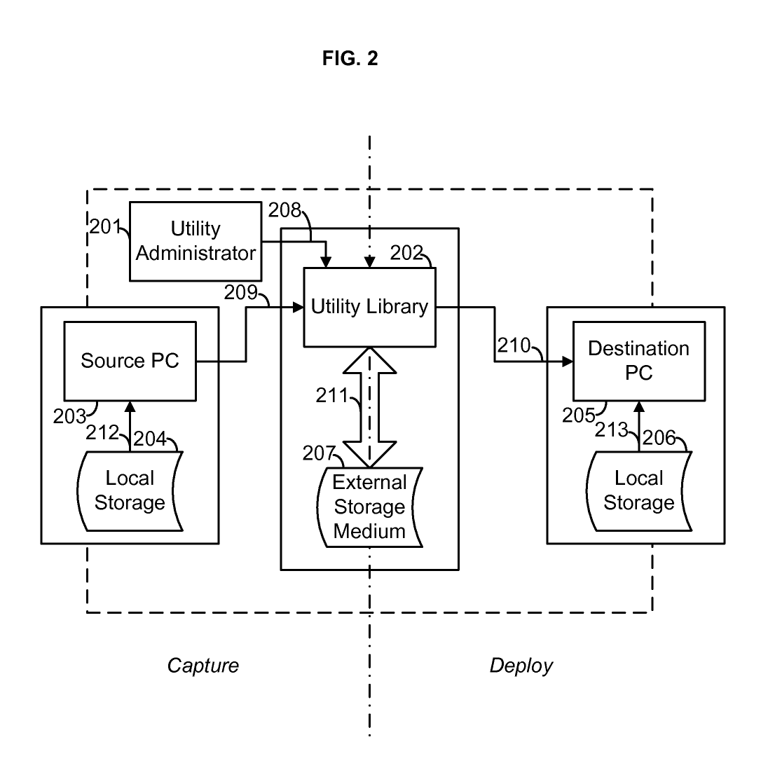

In an aspect, illustrated in FIG. 2, provided are systems for installing and configuring a tailored operating system and user environment. Utility administrator 201 can be an operator or end user performing the process. Utility Library 202 can be a system that runs the process. Source PC 203 can be system that contains the operating environment and/or dataset to be captured. Local Storage 204 can be locally attached storage that contains the operating environment and/or dataset to be captured from the Source PC 203. Destination PC 205 the system that will receive the operating environment or the operating environment and dataset. Local Storage 206 can be the locally attached storage that will receive the operating environment or operating environment and dataset to be deployed to the Destination PC 205.

External Storage Medium 207 can be a storage medium that supports multiple capture or deploy processes running in parallel.

Connection 208 from Utility Administrator 201 to Utility Library 202 illustrates that the Utility Library 202 can utilize outside interaction from the Utility Administrator 201 to initiate the process. Connection 209 from Source PC 203 to Utility Library 202 illustrates the flow of the operating environment and data from the Source PC 203 to the Utility Library 202. Connection 210 from Utility Library 202 to Destination PC 205 illustrates the flow of the captured operating environment and data from the Utility Library 202 to the Destination PC 205.

Connection 211 from Utility Library 202 to External Storage Medium 207 illustrates the two way flow of operating environments and data sets being stored or deployed, from the Utility Library 202 and its External Storage Medium 207. Connection 212 from Local Storage 204 to Source PC 203 illustrates the local storage that is directly attached to the Source PC 203. The operating environment and data can be captured from Local Storage 204.

Connection 213 from Local Storage 206 to Destination PC 205 illustrates the local storage that is directly attached to the Destination PC 205. The operating environment and data will be deployed to Local Storage 206.

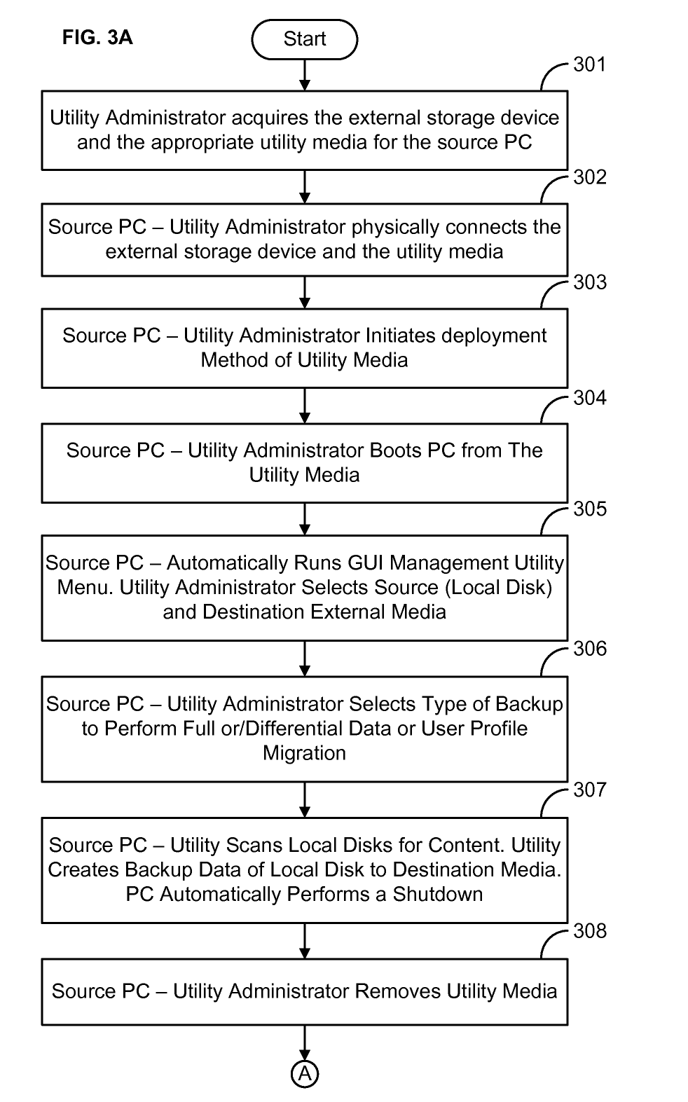

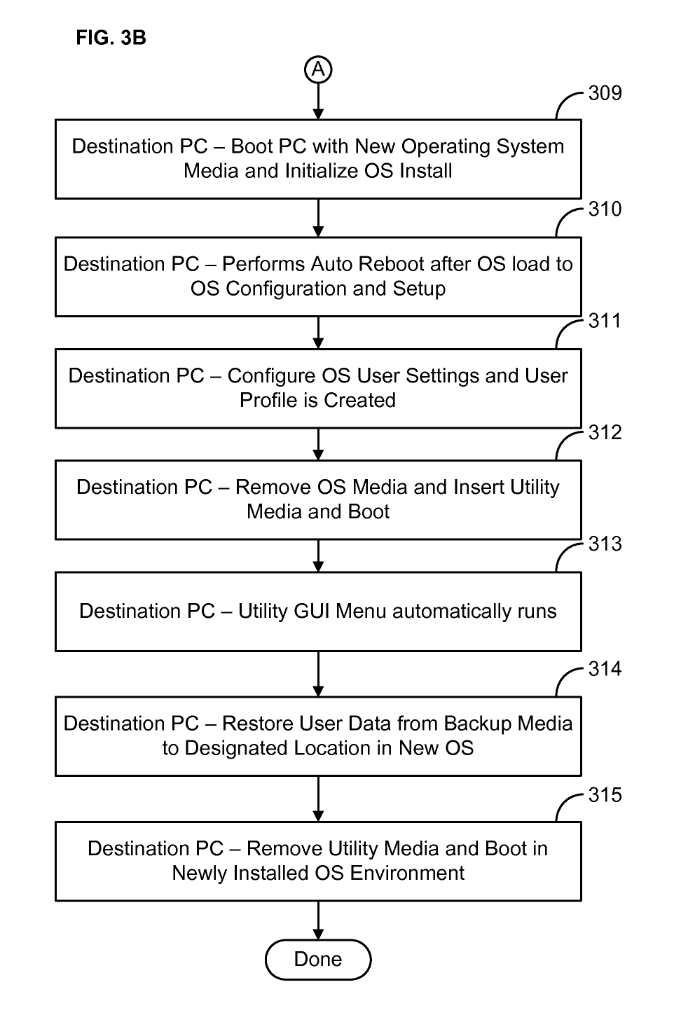

In an aspect, illustrated in FIG. 3A and FIG. 3B, provided are methods for installing and configuring a tailored operating system and user environment. In an aspect, illustrated in FIG. 3A, the following steps can be implemented and carried out on a source PC. At block 301, the media containing the utility and the external storage device are identified and noted for acquisition. The utility medium and external storage medium can be locally connected to the source PC. Additionally, the utility medium and the external storage medium can be the same medium. At block 302, on the designated source PC, a user can make the utility media available to source personal computer. Performing these tasks locally at the physical location of the source personal computer can require a physical connection of the utility and external storage media, alternatively a wireless connection can be used. Otherwise, access to the destination PC and control of the utility may be through a network connection.

At block 303, the source PC can be restarted using the dedicated memory resident operating system hosting Maintenance Operating Environment (MOE) media. At block 304, the maintenance operating system initializes itself. In an aspect, the initialization can be in RAM. Then the Maintenance Operating Environment is established by executing the utility automatically.

At block 305, the GUI menu can be displayed and request input to determine the designated source and destination storage devices for the capture phase. In an aspect, the capture process can captures files on the designated system disk where the operating system is resident. Other hard disks attached to the system can be accessed or can be ignored. The destination storage device is typically the external storage device that has been attached for this procedure. However, it can also be another hard disk or network share.

At block 306, the GUI menu can accept the source and destination devices. Additionally, it will require input as to the type of capture/backup to perform. Capture an individual user or multiple users may be selected for capture/backup. Additionally, a full or differential data may be selected of the user files. A “Full Data Backup” is a copy of all user data associated with the selected user. A “Differential Data Backup” is a copy of files that have changed since the last full data backup. This can be referred to as a delta backup in the computer industry.

At block 307, the Utility can perform a Scan utilizing parameters from block 306 to identify user files, types, personal settings, and the like. The information gathered can stored within the Maintenance Operating Environment and used as the list of items to capture/backup. The Scan utility continues to the capture phase and a capture containing the user and files is performed. The user data from the capture can be stored on the designated external storage device, or in another aspect, stored at a remote location.

At block 308, when complete, the Maintenance Operating Environment can shutdown automatically. At this point the Source personal computer/workstation tasks are complete. The technician can remove the utility medium at this point.

In an aspect, illustrated in FIG. 3B, the following steps can carried out or implemented on the destination PC (the destination PC may be the same physical PC than the source PC or a different PC). At block 309, installation of the OS on the destination PC can be from a standard off the shelf release or a tailored customer image. Large enterprise companies typically produce multiple department images. At block 310, the OS completes its installation and automatically restarts the destination computer. At block 311, the user can configure the newly installed OS on the destination PC with the user profile and user settings.

At block 312, the destination PC can be restarted using the dedicated memory resident operating system hosting Maintenance Operating Environment (MOE) medium. At block 313, the maintenance operating system initializes itself on a RAM Disk. Then the Maintenance Operating Environment is established by executing the utility automatically.

At block 314, the GUI menu can request the utility administrator to select the user profiles to build the destination PC and operating environment. When this is complete, the Maintenance Operating Environment can automatically shutdown. At block 315, boot the destination personal computer with the new Operating System and data.

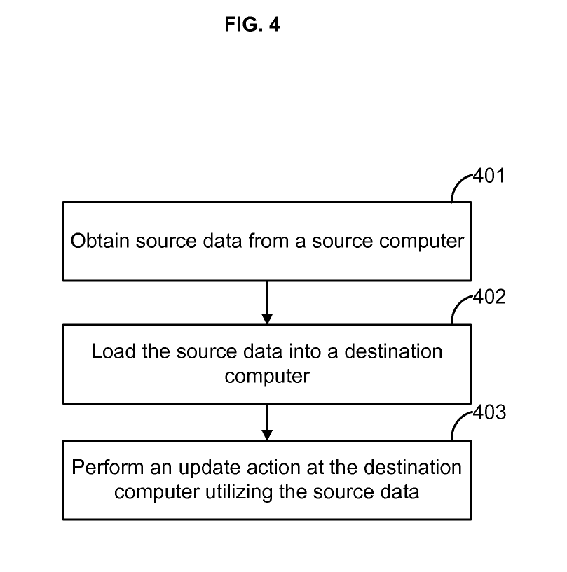

In an aspect, illustrated in FIG. 4, provided are methods for installing and configuring a tailored operating system and user environment comprising obtaining source data from a source computer at block 401. Loading the source data into the destination computer at block 402. Performing an update action at the destination computer utilizing the source data at block 403. In an aspect, the source computer and the destination computer can be the same computer.

Obtaining source data from a source computer can comprise inserting an external storage medium into the source computer. Obtaining source data can further comprise executing software on the external storage medium to harvest the source data. The source data can comprise user settings, installed applications, data files, and the like. Source data can be associated with a single user, or with multiple users. The external storage medium can comprise one or more of a CD, a DVD, a USB drive, and the like.

Obtaining source data from a source computer can comprise booting a maintenance operating system on the source computer from the external storage medium. Obtaining source data from a source computer can further comprise loading a maintenance operating environment comprising the maintenance operating system and a utility library on the source computer. In an aspect, the maintenance operating environment can permit operating system maintenance, operating system upgrades, user migrations, and the like.

Loading the source data into the destination computer can comprise transferring the source data from the external storage medium to a storage device local to the destination computer.

Performing an update action at the destination computer utilizing the source data can comprise customizing a newly installed operating system on the destination computer, installing software applications, transferring stored data files to the destination computer, and the like.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
obtaining source data from a source computer;
loading the source data into the destination computer; and
performing an update action at the destination computer utilizing the source data at block.

2. The method of claim 1, wherein the source data comprises at least one of user settings, data files, or installed applications.

3. The method of claim 1, wherein obtaining source data from a source computer comprises booting a maintenance operating system on the source computer from an external storage medium.

4. The method of claim 3, wherein obtaining source data from a source computer further comprises loading a maintenance operating environment comprising the maintenance operating system and a utility library on the source computer.

5. The method of claim 4, wherein the maintenance operating environment is configured to perform at least one of operating system maintenance, operating system upgrades, and user migrations.

6. The method of claim 1, wherein performing an update action at the destination computer utilizing the source data comprises one or more of customizing a newly installed operating system on the destination computer, installing software applications on the destination computer, and transferring stored data files to the destination computer.

7. An apparatus comprising:
a memory, configured for storing source data, a maintenance operating system, and a utility library; and
a data interface, configured for communicating with a computer to send and receive at least a portion of the source data, the maintenance operating system, and the utility library.

8. The apparatus of claim 7, wherein source data comprises at least one of user settings, data files, or installed applications.

9. The apparatus of claim 7, wherein the apparatus is configured to permit a computer to boot the maintenance operating system

10. The apparatus of claim 9, wherein the apparatus is configured to permit a computer to load a maintenance operating environment comprising the maintenance operating system and the utility library.

11. The apparatus of claim 10, wherein the maintenance operating environment is configured to perform at least one of operating system maintenance, operating system upgrades, and user migrations.

12. A system comprising:
a source computer, comprising source data;
a destination computer; and
a utility medium, configured to
retrieve the source data from the source computer,
load the source data onto the destination computer, and
configure the destination computer based on the source data.

13. The system of claim 12, wherein source data comprises at least one of user settings, data files, or installed applications.

14. The system of claim 12, wherein the utility medium is a CD, a DVD, or a USB Drive.

15. The system of claim 12, wherein retrieving source data from the source computer comprises booting a maintenance operating system on the source computer from the utility medium.

16. The system of claim 15, wherein retrieving source data from the source computer further comprises loading a maintenance operating environment comprising the maintenance operating system and a utility library on the source computer.

17. The system of claim 16, wherein the maintenance operating environment is configured to perform at least one of operating system maintenance, operating system upgrades, and user migrations.

18. The system of claim 17, wherein configuring the destination computer based on the source data comprises one or more of customizing a newly installed operating system on the destination computer, installing software applications on the destination computer, and transferring stored data files to the destination computer.
